(19) United States
(12) Patent Application Publication
(10) Pub. No.: US 2014/0272181 A1
(43) Pub. Date: Sep. 18, 2014

(54) APPARATUS AND METHOD FOR ION IMPLANTATION IN A MAGNETIC FIELD

(71) Applicant: Varian Semiconductor Equipment Associates, Inc., Gloucester, MA (US)

(72) Inventors: Alexander C. Kontos, Beverly, MA (US); Frank Sinclair, Quincy, MA (US); Rajesh Dorai, Woburn, MA (US)

(21) Appl. No.: 13/829,755

(22) Filed: Mar. 14, 2013

(51) Int. Cl. G11B 5/84

(52) U.S. Cl. CPC G11B 5/84
USPC 427/523; 118/723 R

(57) ABSTRACT

In one embodiment, a system for treating a magnetic layer includes an ion generating apparatus for directing an ion beam to the substrate and a magnetic alignment apparatus downstream of the ion generating apparatus and proximate to the substrate and operative to generate a magnetic field that intercepts the substrate in an out of plane orientation with respect to a plane of the substrate. The magnetic alignment apparatus and ion generating apparatus generate a process region in which the ion beam and magnetic field overlap.

### FIELD OF INVENTION

This invention relates to magnetic recording and, more particularly, to ion implantation to improve magnetic recording media.

### BACKGROUND

It is the goal for many commercial applications to improve the quality of thin magnetic layers that may be used as recording media for various technologies including heat assisted magnetic recording (HAMR) devices, magnetic random access memory (MRAM) and other memory or recording technology. In particular, a central challenge for present day magnetic recording is to increase the storage density in a given magnetic medium/magnetic memory technology. Several features of magnetic materials place challenges on density scaling for magnetic media. For one, memory density may be limited by the grain size of the magnetic layer, which is related to the magnetic domain size and therefore the minimum size for storing a bit of information. Secondly, the ability to read and write data in a magnetic layer is affected by the magnetocrystalline anisotropy of the material. In some cases, it may be desirable to align the easy axis of the magnetic material along a predetermined direction, such as along a perpendicular to the film plane for perpendicular memory applications.

Recently, magnetic alloys, and in particular, CoPt, CoPd, and FePt films have shown promise for high density magnetic storage. In particular, CoPt, CoFe, FePt and related materials form a tetragonal “L1₀” phase having high magnetocrystalline anisotropy and exhibiting the ability to form small crystallite (grain) size, both desirable features for high density magnetic storage. The L1₀ phase is believed to be the thermodynamically stable phase at room temperature for materials such as CoPt. However, when thin layers are prepared under typical conditions, such as being deposited by physical vapor deposition on unheated substrates, the face centered cubice (FCC) A1 phase is typically found. Preparation of the “L1₀” phase typically involves high temperature deposition of a thin film such as CoPt and/or high temperature post-deposition annealing, both of which may impact the ability to achieve the desired magnetic properties, and which may deleteriously affect other components of a magnetic device that are not designed for high temperature processing. Similarly, in the case of FePt films deposited at room temperature, the initial film structure is a disordered alloy A1 structure that requires annealing at about 500-600° C. to yield the ordered L1₀ face-centered-tetragonal (FCT) structure. Upon annealing, the grain size of such films may exceed desired limits for high density storage.

Recently, ion implantation of FePt was observed to reduce the amount of post deposition heat treatment required to form the L1₀ phase. By reducing the amount of thermal treatment required to form the desired L1₀ phase, the grain size may be maintained at a smaller level, thereby potentially increasing the storage density of magnetic media formed by such a process. However, for perpendicular magnetic data recording using materials such as L1₀ FePt, it is desirable to align the easy axis of the FCT phase along a desired direction to allow convenient reading and writing of data.

In this regard, conventional approaches suffer in that the microstructure of such L1₀ structures is less than ideal for high density storage. FIGS. 1A-1D depict an example of problems with the conventional approaches for forming the L1₀ phase. The coating material 102 is illustrated as deposited on a substrate 104, which may be any appropriate substrate. It is to be emphasized that the relative thickness of layers is not necessarily drawn to scale. For high density storage materials, such as perpendicular recording media, the layer thickness of such a coating material 102 may be below 100 nm and is some cases as thin as about 10 nm or less. Coatings may be deposited by vacuum deposition methods such as physical vapor deposition (PVD) as noted. As deposited, the coating material 102 is shown as having an FCC crystal structure in the close up view of FIG. 1a. In the FCC structure (also termed A1) for FePt, an iron atom may occupy any site of the FCC lattice as is also the case for platinum. The atoms of the material 102 are therefore represented by the same appearance. As noted, in prior art approaches, the use of heat treatment at temperatures in excess of 300° C. and typically in the range of 500-700° C. may result in the formation of the FCT phase as illustrated in FIGS. 1b to 1d. In particular, the coating material 102 is transformed into the coating material 110, which has the same overall composition as the coating material 102, such as FePt. However, the FCT phase is an ordered structure in which each Fe atom resides on a first set of lattice sites, while each Pt atom resides on a second set of lattice sites, such that the Pt atoms 112 arrange in planes of like atoms that are interleaved with planes of Fe atoms 114, as shown. In this L1₀ structure, the easy direction 116 of magnetization lies along the “c” axis of the FCT structure.

Although ion treatment may reduce the heat treatment or temperature of formation of the FCT phase having the L1₀ structure, in general, crystallites of FePt or other magnetic materials having the FCT L1₀ structure may assume any of multiple orientations after formation of the FCT phase. FIGS. 1B to 1D provide examples of different orientations that may be assumed by crystallites within a coating. The coating material of FIG. 1B, which is also denoted as coating material 110a to indicate a particular crystalline orientation, may represent one or more FCT crystallites formed from the coating material 102 having the FCC phase. As shown, coating material 110a exhibits an orientation in which the easy direction 116 is oriented perpendicular to the plane of the substrate 104, which is desirable for perpendicular storage applications. The coating material 110b of FIG. 1C exhibits an easy direction 116 that lies parallel to the plane of the substrate 104, which is less desirable for perpendicular storage. Finally, the coating material 110c of FIG. 2d has an easy direction 116 that forms a non-zero angle with respect to the plane of substrate 104, which is also less desirable for perpendicular storage.

Heretofore, apparatus and techniques are lacking to produce a microstructure in which the easy direction 116 of the L1₀ FePt is aligned along a perpendicular to the film, and in particular to perform such treatment at low temperature. Although the use of crystalline substrates such as MgO to promote epitaxial growth may be helpful, such approaches limit the flexibility of substrates for synthesizing magnetic layers and in any case may not result in formation of L1₀ FePt having the degree of easy axis alignment desired. Moreover, although magnetic fields have been applied to coatings, these fields are arranged within the plane of the substrate and are not well suited for aligning the easy axis perpendicular to the plane of the substrate. What is needed is an improved method and apparatus of forming perpendicular magnetic recording layers and devices.

### SUMMARY

This Summary is provided to introduce a selection of concepts in a simplified form that are further described below in the Detailed Description, and is not intended to identify key features or essential features of the claimed subject matter, nor is it intended as an aid in determining the scope of the claimed subject matter.

In one embodiment, a system for treating a magnetic layer is provided that an ion generating apparatus for directing an ion beam to the substrate and a magnetic alignment apparatus downstream of the ion generating apparatus and proximate to the substrate and operative to generate a magnetic field that intercepts the substrate in an out of plane orientation with respect to a plane of the substrate. The magnetic alignment apparatus and ion generating apparatus generate a process region in which the ion beam and magnetic field overlap.

In a further embodiment, a method for treating a substrate having a magnetic layer includes arranging a substrate that includes the magnetic layer, generating over a first area of the substrate a magnetic field in a magnetic field direction out of plane relative to a plane of the substrate, and directing an ion beam over a second area of the substrate, wherein the first area and second area overlap at the substrate to define a process region.

### BRIEF DESCRIPTION OF THE DRAWINGS

FIGS. 1A-1D depict the results of conventional processing for a magnetic material;

FIGS. 2A-2D depict an example of results for treating magnetic material according to the present embodiments;

FIG. 3A depicts an embodiment of a system for treating a magnetic layer;

FIG. 3B depicts another embodiment of a system for treating a magnetic layer;

FIG. 4A depicts a side view of an embodiment of a system for treating a magnetic layer;

FIG. 4B depicts a perspective view of the system of FIG. 4A;

FIG. 4C depicts an exploded perspective view for use of the system of FIG. 4A;

FIG. 5A depicts a side view the system of FIG. 4A during operation under one scenario for treatment of a magnetic layer;

FIG. 5B depicts a perspective view of the scenario of FIG. 5A;

FIG. 5C depicts an exploded perspective view of the scenario of FIG. 5A;

FIG. 5D depicts a top plan view of the scenario of FIG. 5A;

FIG. 5E depicts a top plan view the system of FIG. 4A during operation under another scenario for treatment of a magnetic layer;

FIG. 6 depicts details of processing a magnetic layer using a magnetic alignment apparatus of the present embodiments; and

FIG. 7 depicts another embodiment of a system for treating a magnetic layer.

### DETAILED DESCRIPTION

The embodiments described herein provide apparatus and methods for treating magnetic media, such as magnetic layers (also termed “films”) that form part of a recording or storage device. In particular, embodiments are directed to providing improved perpendicular magnetic storage devices including high density heat assisted magnetic recording HAMR storage, MRAM, and other devices. The present embodiments provide a novel combination of the application of magnetic fields and ion treatment to align the microstructure of a magnetic layer along a desired direction. In particular variants, the present embodiments may be used to align a magnetic material having a strong magnetocrystalline anisotropy to provide alignment of the easy axis of the material along a desired direction. Examples of such materials include iron compounds having the face centered tetragonal L1₀ structure including FePt and CoPt (although L1₀ structure is an example of a face centered tetragonal structure, the terms L1₀ and FCT are used herein generally interchangeably or in combination to refer to a magnetic alloy having the L1₀ structure).

As noted, the FePt L1₀ structure represents an ordered phase as compared to an FCC variant of the same composition (FePt) in which the atoms of Fe and Pt are randomly distributed at any lattice site of the FCC structure. The L1₀ phase is particularly favored for high density perpendicular magnetic storage applications because of its high magnetocrystalline anisotropy and its ability to form small grains. Consistent with the present embodiments apparatus and methods are provided to produce a highly oriented magnetic layer in which the easy axis (also termed herein “easy direction”) of magnetization is oriented perpendicular to the plane of the substrate and film that constitutes the magnetic storage medium.

FIGS. 2A-2D depict one example of operation of the present embodiments. FIG. 2A depicts an example of using the coating material 202 as a precursor to a final coating having a desired microstructure for perpendicular magnetic storage. The coating material 202 may be a magnetic material that is deposited on a substrate 204, which may be any desired structure including an electronic circuit such as an MRAM device structure. As illustrated the coating material exhibits the FCC structure as described above for coating material 102, which is often the case for FePt, CoPt, FePd and similar materials when deposited at room temperature. Consistent with the present embodiments, treatment 206 may be provided to the coating material 202, which constitutes a combination of magnetic field and ion beam exposure. The treatment 206 results in the formation of a desired microstructure represented by the coating 208a of FIG. 2b. As shown in FIG. 2B, one unit cell of a crystallite having the aforementioned L1₀ structure is oriented such that the easy direction 116 is perpendicular to the plane of substrate 204 (shown only in FIG. 2A for clarity but having the same orientation in the FIGS. 2A-2D). The c-axis of the FCT phase is thus oriented perpendicular to the plane of the substrate 204 such that layers of atoms 210, which may be iron or cobalt in some examples, are interleaved with layers of atoms 212, which may be platinum, or alternatively palladium, in other examples. The embodiments are not limited in this context. As described in more detail below, this orientation may be imparted into multiple small crystallites of the FCT phase such that the overall coating 208a has superior magnetic properties, especially for the purposes of high density perpendicular magnetic storage. FIGS. 2C and 2D depict two (among many) additional possible coating microstructures 208b and 208c, respectively, in which the easy direction 116 is oriented in different directions but parallel to the plane of the substrate 204. As also described below, the presence of these and other orientations may be reduced by use of the apparatus and techniques of the present embodiments, resulting in layers having a higher degree of the microstructure represented by the coating 208a of FIG. 2b.

In various embodiments, a system for treating magnetic layers includes a component to generate an ion beam to treat the magnetic layer and a component to generate a magnetic field to provide magnetic alignment to the layer, which may occur during exposure to the ion beam. In particular embodiments, the system may also include heating devices to provide heat treatment to the magnetic layers during exposure to the ion beam and magnetic field. The exposure to the ion beam may be particularly effective in reducing the amount of heat treatment, if any, to be applied to a magnetic material in order to induce a desired microstructure, such as the L1₀ structure for FePt, CoPt, FePd, and similar materials. The exposure of the magnetic layer to the magnetic field provided by apparatus of the present embodiments may be particularly effective in aligning crystallites of the magnetic material such that the easy axis is oriented perpendicularly to the plane of the film.

FIG. 3A depicts a system 300 for treating a magnetic layer consistent with another embodiment. In the present embodiment, the system 300 includes an ion generating apparatus 302. In some embodiments, the ion generating apparatus 302 may optionally include ion implantation components such as a magnetic analyzer, electrostatic lenses (all not shown), scanner, collimating lens, ion energy filter, and the like, which may control the ions generated from the ion source as an ion beam 304 and direct the ion beam 304 toward the substrate 314. Such components may orient the ion beam 304 relative to the substrate at a desired angle, control the ions in the ion beam 304 such that the ions are substantially parallel to one another, control the ion beam 304 such that the ions in the ion beam 304 may be uniform in energy. In other embodiments the ions may be directed toward the substrate as a bias or potential is applied to the substrate 314 to attract the ions generated from the ion source. For example, a potential may be applied to the substrate via a magnetic alignment apparatus 306, including components therein, so as to bias the substrate 314 to a desired voltage level with respect to the ions to attract ions of the appropriate energy generated in an ion source to impinge on a magnetic layer of the substrate. In various embodiments, the ion generating apparatus 402 may generate ions that are effective in inducing defects in a magnetic layer so as to accelerate a transformation from a disordered to an ordered structure, such as a transformation of an FCC FePt, FePd, or CoPt material, to name a few examples, into an L1₀ (FCT) structure. In some instances, the ions of ion beam 304 maybe ions of inert species including hydrogen (H), or nitrogen (N). The ions of inert species may also include noble species such as helium (He), neon (Ne), argon (Ar), or krypton (Kr), or xenon (Xe). In particular, light ions such as helium and hydrogen may be especially effective in introducing mobile vacancies into the magnetic material to facilitate phase transformation from the FCC to FCT phase. The embodiments are not limited in this context.

In some examples, helium ions are provided in the ion beam 304 at an ion energy of about 5 keV to about 50 keV. The ion energy used to effect the transformation from FCC to FCT phase may be increased with increases in film thickness as is known. Exemplary ion doses effective for transforming an FCC layer into an FCT layer may range from about 1E13 to 1E15 for layer thicknesses of magnetic layers less than about 50 nm. The embodiments are not limited in this context.

As illustrated in FIG. 3A, the magnetic alignment apparatus 306 of the present embodiment, whose components are shown in a side cross-sectional view, includes a magnet 308, which is operative to generate a magnetic field 310. In various embodiments, the magnet 308 may be a permanent magnet or an electromagnet. In some embodiments, the magnetic alignment apparatus may include a magnetic field provider 312 disposed between the magnet 308 and substrate 314. The magnetic field provider 312 may act to provide the magnetic field 310 generated by the magnet 308 to regions proximate substrate 314. In particular, the magnetic field provider 312 may act to provide magnetic field lines of the magnetic field 310 that are oriented out of plane in regions proximate the substrate 314. The term “out of plane” as used herein, refers to a direction or set of directions that is not parallel to a surface of the substrate 316, as represented by the “in-plane” direction 318. For example, in some instances an out of plane orientation of filed lines may constitute field lines that form an angle of greater than fifteen degrees with respect to the direction 318.

By arranging the out of plane orientation of field lines of a magnetic field, the magnetic alignment apparatus 306 may facilitate the ability to orient the easy axis of a magnetically anisotropic layer along a desired direction. In some embodiments, the magnet 308 and magnetic field provider 312 may be interoperative to provide magnetic field lines of the magnetic field 310 that are generally perpendicular to the surface 316, as suggested in FIG. 3A. In addition, by arranging the orientation of field lines of a magnetic field along a specific out of plane direction, the coupling of the magnetic field to incident ions can be minimized. For example, in embodiments in which the magnetic field lines of magnetic field 310 are oriented perpendicularly to the surface 316, the ions of the ion beam 304 may simultaneously be directed perpendicularly to the surface 316 when striking the substrate 314. By providing a magnetic field 310 whose field lines are oriented generally parallel to ion of the ion beam 304, the present embodiments facilitate novel processing of magnetic material disposed on the substrate 314. In particular the system 300 and variants thereof discussed below provide the ability to simultaneously form a highly magnetically anisotropic structure, such as the face centered tetragonal L1₀ structure, and to the easy axis of such a structure perpendicularly to the surface 316 of the substrate 314. At the same time, the perturbation of ions of the ion beam 304 may be minimized when the ions are directed perpendicularly to the surface 316, that is, parallel to the magnetic field lines of the magnetic field 310.

In various embodiments, the system 300 may be configured to maintain the substrate 314 stationary while treatment from the ion beam 304 and magnetic field takes place. While in other embodiments, the substrate 314 may be movable during treatment. In some embodiments, the substrate 314 may not be in contact with the magnetic field provider, while in other embodiments the substrate 314 and/or a substrate holder (platen) may be brought into contact with the magnetic field provider. For example, the magnetic field provider 312 may act as a support structure such as a substrate holder in some instances. Although not explicitly shown, the magnetic field provider 312 may be translatable, tiltable, and/or rotatable with respect to the ion beam 304.

FIG. 3B depicts a system 320, which is a variant of the system 300 of FIG. 3A. The system 320 includes a magnetic alignment apparatus 322 that includes the magnetic field provider 312, which acts as a support structure, and an electromagnet 324. The electromagnet 324 may be configured in a coil structure that is operative to generate a magnetic field 326 whose filed lines are oriented similarly to those of magnetic field 310 of the system 300.

FIG. 4A depicts an embodiment of a system 400 for treating a magnetic layer consistent with another embodiment. In the present embodiment, the system 400 includes the ion generating apparatus 302 discussed above, which may include an ion source for generating ions of a desired species. FIG. 4A particularly depicts a side cross-sectional view of magnetic alignment apparatus 402. As illustrated in FIG. 4A, the magnetic alignment apparatus 402 includes a magnetic coil 404 that surrounds a magnetic concentrator 408 and a return yoke 406. The magnetic concentrator 408 acts as a magnetic field provider to provide a magnetic field of a desired orientation at a location As detailed below, the magnetic concentrator 408 magnetic coil 404 and return yoke 406 are operative to provide a highly directional, for example unidirectional, and high strength magnetic field (e.g. >0.1T) in a substrate location, such that a substrate and magnetic layer may be exposed to a magnetic field that lies perpendicular to the substrate plane while simultaneously receiving exposure to an ion beam (shown in FIGS. 5A-5D). The magnetic concentrator 408 of the present embodiment may have a tapered shape, which may be conical in various embodiments. As illustrated, an upper portion 410 of the magnetic concentrator 408 may taper inwardly so that an upper portion 410 has a smaller area than that of a base portion 411.

In the present embodiments, the magnetic concentrator 408 may be a steel material that acts to place a strong magnetic field in a region that includes the upper portion 410. As shown in FIGS. 4B and 4C, the magnetic coil 404 may be disposed around the magnetic concentrator 408. In various embodiments, the magnetic coil 404 may be a permanent magnet, while in other embodiments, the magnetic coil may be an electromagnet. The magnetic coil 404 may assume an elongated “racetrack” shape as generally illustrated in FIGS. 4B and 4C, which surrounds the elongated base portion of the magnetic concentrator 408.

As further shown in FIG. 4A, the magnetic alignment apparatus 402 is designed to accommodate a substrate holder 414 that supports the substrate 416. In various embodiments, the magnetic alignment apparatus 402 may be coupled to components (not shown) that provide, with respect to an ion beam (shown in FIGS. 5A-5D) a translation motion, a tilt motion, and/or a rotation motion, or any combination of the above. In some embodiments the substrate holder 414 may include a substrate platen and/or substrate stage that is operative to move the substrate 416 at least along the direction 418 through a gap that contains two gap portions 420, each of which separates an upper portion 412 from lower portion 411 of return yoke 406.

As additionally shown in FIG. 4A, the return yoke 418 includes an aperture 424 defined between distal portions 428 of return yoke 406. The aperture 424 is aligned over the upper surface 426 of the magnetic concentrator such all portions of the upper surface 426 may be exposed to a perpendicular ion beam without obstruction. In this manner different regions of substrate 416 may be conveyed through the aperture 424 and exposed simultaneously to a magnetic field and ion bombardment as discussed below. As shown, the substrate holder 414 may move the substrate 416 along the direction 418 such that the substrate 416 enters into the aperture 424.

In some embodiments, the magnetic alignment apparatus 402 may form part of an ion implantation system. In some embodiments, the ion generating apparatus 302 may optionally include ion implantation components such as a magnetic analyzer, electrostatic lenses (all not shown), scanner, collimating lens, ion energy filter, and the like, which may control the ions generated from an ion source as shown below with respect to FIGS. 5A-5C.

Turning now to FIGS. 4B and 4C there are shown a perspective view and exploded perspective view the magnetic alignment apparatus 402. For clarity in FIG. 4C upper portion 412 of the return yoke 406 is not shown. As illustrated by the change in position of the edge 430 of substrate holder 416 between FIG. 4A and FIG. 4B, the substrate holder 414 may be drawn along the direction 418 through the aperture 424. In this example, the magnetic coil 404 and magnetic concentrator 408 are elongated along the Y-direction with respect to the Cartesian coordinate system shown. In various embodiments, the magnetic alignment apparatus 412 may define a process region in which an out of plane magnetic field and ion beam, which may be a ribbon ion beam or spot beam, overlap

In the embodiment suggested by FIG. 4C, when an ion beam (shown in FIGS. 5A-5C) is incident on the magnetic alignment apparatus 402 and the substrate holder 414 is drawn along the X-direction, that is, direction 418, different portions of the substrate 416 are drawn through an elongated process region 422 discussed below with respect to FIGS. 5A-5D.

Turning now to FIG. 5A there is shown one scenario of operation of the magnetic alignment apparatus 402. As illustrated, the magnetic coils 404 generate a magnetic field 502 whose field lines extend from the upper portion 412 of the return yoke 406 into the upper portion 410 of the magnetic concentrator 408. The tapered shape of the magnetic concentrator 408 helps to generate field lines of the magnetic field 502 that extend out of plane with respect to the plane 500 of substrate 416. In the specific embodiment shown in FIGS. 5A to 5D, the magnetic filed 502 is generally perpendicular to the plane 500 of substrate 416 in the process region 422 where the substrate 416 intercepts the magnetic field 502. Other portions of the magnetic field 502 (not shown for clarity), may then bend outwardly and downwardly through the return yoke 406 and into the magnetic coil 404. However, in other embodiments the field lines of magnetic field 502 may extend out of plane with respect to the substrate plane 500 at a non-perpendicular angle if desired.

At the same time as the magnetic alignment apparatus 402 generates the magnetic field 502, in the scenario of FIG. 5A, an ion beam 504 is directed toward the substrate 416. Together the ion beam 504 and magnetic field 502 are operative to generate the elongated process region 422. This elongated process region 422 represents a region in which the ion beam 504 overlaps the magnetic field 502 where field lines of the magnetic field are oriented out of plane with respect to a plane 500 of substrate 416. Thus, portions of the substrate 416 that are within the elongated process region 422 are subject to simultaneous impact by ions of the ion beam 504 and out of plane magnetic alignment induced by the magnetic field 502.

Turning also to FIGS. 5B and 5C there are shown a perspective view and exploded perspective view of lower portions of the magnetic alignment apparatus 402 during the operation depicted in FIG. 5A. For clarity upper portion 412 of the return yoke 406 is not shown. As specifically depicted in FIG. 5C, the magnetic field 502 includes field lines that extend generally perpendicularly to the plane 500 along the width W of the magnetic concentrator 408 so as to define an elongated out of plane magnetic field portion having a width about equal to W.

FIG. 5D depicts illustrates a top plan view of the arrangement of FIGS. 5A-5C. As illustrated, the ion beam 504, which may have a ribbon shape (see FIGS. 5B-5C) has a width W₂ when it intercepts the substrate 416, where width W₂ may equal or exceed the width W₃ (in this case a diameter) of the substrate 416. Thus, when properly aligned, the substrate 416 may be drawn along the direction 418 such that the entire width W₃ is exposed to the ion beam 504 at any given time. Moreover, the width W of the magnetic concentrator 408 may be equal to or greater than W₂ so that the entire width W₂ is exposed to out of plane field lines of the magnetic field 502 at any given time.

As further illustrated in FIGS. 5D and 4C, and consistent with various embodiments, the system 400 is configured so that the ion beam 504 and magnetic field 502 overlap at the plane 500 of the substrate 416 to generate the elongated process region 422 with a width W₄ along a long direction that is greater than its length L. In various embodiments the width W₄ may range between several centimeters to one hundred centimeters and the Length L may range from one millimeter to several centimeters. In particular embodiments the width W₄ the elongated process region 422 is arranged to be equal to or greater than the width W of a substrate to be processed. In the particular embodiment of FIGS. 5A-5D, the elongated process region 422 thus formed represents a region in which magnetic field lines that extend generally perpendicularly with respect to the plane 500 of substrate 416 overlap with an ion beam such as the ion beam 504. Portions of a substrate 416 that intercept the elongated process region 422 are subject to simultaneous ion bombardment from ion beam 504 and magnetic field alignment along the generally perpendicular direction of the field lines of magnetic field 502 at the plane 500.

In the example of FIG. 5A-5D simultaneous exposure to an ion beam 504 and (generally perpendicular) magnetic field 502 may be uniformly applied across the substrate 416 in the following manner. The substrate 416 may be generally centered along the Y-direction with respect to the magnetic alignment apparatus 402. The ion beam generating apparatus 302 may be adjusted so that the ion beam 504 and magnetic field 502 overlap and generally produce elongated patterns whose long directions are mutually parallel at the level of the substrate plane as illustrated in FIGS. 5A and 5D. The substrate holder 414 may then be moved in one or multiple passes through the elongated process region 422 along a direction 418 that is generally perpendicular to the long direction of the elongated process region 422. In this manner, during each pass the full diameter of the substrate 416 is covered by the elongated process region 422 ensuring that the entire substrate 416 is exposed to the elongated process region 422.

In various embodiments the ions 506 of the ion beam 504 be oriented relative to the substrate 416 at a desired angle, and control the ions 506 such that the ions 506 are substantially parallel to one another, and/or of uniform ion energy. In other embodiments the ions 506 may be directed toward the substrate 416 as a bias or potential is applied to the substrate 416 to attract the ions 506 generated from an ion source.

FIG. 5E depicts a top plan view the system of FIG. 4A during operation under another scenario for treatment of a magnetic layer. In this case, a spot ion beam 507 of width W₅ is generated, which defines together with the magnetic field 502 a process region 508 having a width W6 that is smaller than the width W3. In one embodiment, to process the entire substrate 416 the spot ion beam 507 may be scanned along the direction 509 parallel to the Y-direction to cover a distance equivalent to W3 while the substrate is moved in the direction 418. The movement of spot ion beam 507 and/or substrate 416 may take place in continuous or step fashion. Other scanning schemes are possible, such as those in which only the substrate 416 is scanned in two orthogonal directions, or the spot beam is scanned in both directions, and so forth. In each of these schemes the process region at any given time has the shape and size as indicated by process region 508 and scanning takes place to cover a desired region of the substrate 416.

Referring also to FIG. 4A, in various embodiments, the ion generating apparatus 302 may generate ions that are effective in inducing defects in a magnetic layer so as to accelerate a transformation from a disordered to an ordered structure, such as a transformation of an FCC FePt, FePd, or CoPt material, to name a few examples, into an L1₀ (FCT) structure. In some instances, the ions of ion beam 404 maybe ions of inert species including hydrogen (H), or nitrogen (N). The ions of inert species may also include noble species such as helium (He), neon (Ne), argon (Ar), or krypton (Kr), or xenon (Xe). In particular, light ions such as helium and hydrogen may be especially effective in introducing mobile vacancies into the magnetic material to facilitate phase transformation from the FCC to FCT phase. The embodiments are not limited in this context.

In some examples, helium ions are provided in the ion beam 504 at an ion energy of about 5 keV to about 50 keV. The ion energy used to effect the transformation from FCC to FCT phase may be increased with increases in film thickness as is known. Exemplary ion doses effective for transforming an FCC layer into an FCT layer may range from about 1E13 to 1E15 for layer thicknesses of magnetic layers less than about 50 nm. The embodiments are not limited in this context.

FIG. 6 depicts one instance in which a substrate 416 includes a magnetic layer 510 which may be exposed to the ion beam 404 during ion implantation. In various embodiments in which the magnetic layer 510 is a material such as a FePt, FePd, CoPt, or similar alloy, the system 400 may treat the layer 510 in the following manner. As previously noted, the magnetic layer 410 may initially be deposited on the substrate 416 while the substrate 416 is unheated or at a relatively low substrate temperature, such as below 300° C. The deposition of magnetic layer 510 at low substrate temperature may be necessary or desirable based on constraints due to other components or materials that may be present on the substrate 416. For example, in embodiments in which the substrate 416 is used to fabricate MRAM devices, various structures of an MRAM integrated circuit may be present at the time the magnetic layer 510 is deposited, at least some of which structures may be deleteriously affected by a high substrate temperature, such as temperatures in the range of 500-700° C. that are typically necessary to transform the FCC magnetic layer into the FCT structure in the absence of ion bombardment. Accordingly, as deposited, the magnetic layer 428 may form in the FCC structure for alloys such as FePt, FePd or CoPt.

In embodiments in which the magnetic layer 510 is an FCC alloy of FePt, FePd, CoPt or other material, the substrate 416 together with the layer magnetic 510 may be placed as shown in FIG. 6. Subsequently, an ion beam 504 is directed toward the substrate 416 in a direction generally perpendicular to the plane of the substrate 416, which plane is represented in cross-section by the line P. In various embodiments, the magnetic layer 428 is disposed at the surface of the substrate 416 when subjected to the ion beam 504. Alternatively, one or more layers (not shown) may be disposed between the magnetic layer 510 and ion beam 504. In either case, the ion energy and ion dose are arranged so as to implant ions within the magnetic layer 510. As is known, upon striking the magnetic layer 510, the ions may create vacancies or other defects that assist in migration of atoms such as Fe and Pt in the case of FePt. The migration may be on a short length scale such that atoms of one species, such as Fe, order on one lattice site, while atoms of another species, such as Pt, order on a different lattice site so as to form the L1₀ structure. Since the atoms of the FCC phase may be intimately and randomly mixed on the FCC lattice at the atomic scale, formation of the FCT structure L1₀ may generally require atomic migration on the length scale of nanometers or less. Thus in some embodiments, the substrate 426 may require no heating or may be heated to temperatures of about 300° C. or less.

Because the magnetic field 502 is also aligned perpendicularly to the plane 500 at the level of the magnetic layer 510 as shown, crystallites of the FCT FePt material or CoPt material may tend to align with their c-axes parallel to the field lines of the magnetic field 502. In other words, the c-axis of the L1₀ structure, which represents the easy direction of magnetization, may also align perpendicularly to the plane P, as is desired for perpendicular reading and writing to devices. Moreover, because treatment may take place at relatively low substrate temperatures (</=300° C.), the crystallite size of the FCT L1₀ layer thus formed may remain small, which is desirable for high density storage.

In order to further evaluate the effect of a magnetic alignment apparatus on treatment of a magnetic layer, the characteristics of magnetic fields have been studied for an apparatus arranged generally according to the aforementioned embodiments, except that the upper magnetic concentrator is not elongated in the Y direction with respect to the X direction. In one example, when the magnetic coil 408 produces a current density of 10 A/cm², a magnetic field of about 0.2 Tesla may be produced at a substrate positioned proximate the upper portion 410. This represents a magnetic field sufficient to align the easy axis of a magnetic material having the L1₀ structure along the z-direction, representing a desirable orientation for perpendicular magnetic storage devices. Thus, an FCT magnetic material disposed on a substrate located proximate the upper surface 410 may be effectively oriented with the c-axis of its crystallites aligned perpendicularly to the plane of the substrate.

Regarding the directionality of the magnetic field produced by a magnetic alignment apparatus arranged consistent with the present embodiments, simulations have shown that at the magnetic field can be aligned perpendicularly to an upper surface of the magnetic concentrator over at least 90% of the upper surface. Thus the length L₁ of the process region 422 in which the magnetic layer 510 is subject to a perpendicularly oriented magnetic field that overlaps with the ion beam 504 may be about the same as the length L₂ of the upper portion of the magnetic concentrator 408.

In addition to providing the ability to magnetically align the microstructure of a material such as FCT FePt so that the easy axis is perpendicular to the substrate plane, the apparatus of the present embodiments provide the further advantage that interference is minimized with an incident ion beam used to bring about transformation into the FCT phase. In this regard, the trajectories of ions incident upon a magnetic alignment apparatus were simulated using phosphorous ions having initially perpendicular trajectories with respect to the plane of a substrate (along the Z-direction of FIG. 6). The results indicate that the trajectories of phosphorous ions only deviate from perpendicular at the upper surface 600 by at most about one half degree. Thus, a substrate 416 arranged as shown in FIG. 6, for example, experiences ions 504 of uniform trajectories for an ion beam incident at a nominally perpendicular angle.

In sum, an apparatus arranged according to the present embodiments can generate, as an example, a perpendicular magnetic field of strength in the range of 0.2 Tesla for a 10 A/cm² electromagnet current, at the position of a substrate that has minimal effect on ion trajectories incidenₜ on the substrate. It is to be noted that the above results are merely exemplary and the values of magnetic field achievable by a magnetic alignment apparatus configured according to the present embodiments may vary according to the size of a magnetic concentrator, a magnetic coil, and return yoke, to name a few parameters.

As evident from the forgoing, and consistent with various embodiments, a highly oriented magnetic layer having a high degree of magnetocrystalline anisotropy may be prepared from a precursor that may be an isotropic and unoriented material, without the need for substrate heating. However, in order to accelerate formation of a desired magnetic layer or to improve the quality of the resulting magnetic layer, substrate heating may be applied concurrently with exposure to ions and a magnetic field. FIG. 7 depicts an embodiment of another system 700 for treating a magnetic layer. The system 700 may have similar components to those described above with respect to FIG. 4A to 6, save the heater(s) 702. As shown in FIG. 7, the heater 702 is embedded in the magnetic concentrator 408. The heater 702 may thereby heat the magnetic concentrator 408 and thereby at least portions of the substrate 416 including those regions proximate the process region 422. Of course other heater arrangements are possible including radiant heaters located above the substrate 416. The embodiment of FIG. 7, may, for example provide substrate heating to temperatures up to 300° C. When a substrate 416 is placed into the system 700 in one instance, the layer 428 may be an FePt material having the FCC structure. In one example of treatment, the FePt material is heated to 300° C. while exposed to the ion beam 504 in the presence of the magnetic field 502. The FePt material thereby transforms into the L1₀ FCT phase having small crystallites that are have a high degree of alignment wherein the c-axes are oriented perpendicularly to the plane of the substrate 516.

In summary the present embodiments provide apparatus and techniques to enhance formation of magnetically aligned regions in a substrate. The embodiments employ an an ion beam to create an elevated vacancy density in a crystalline magnetic material that catalyzes the atomic rearrangements and allows the development of a structure having a lowest magnetic energy, such that the magnetic moments in the magnetic material are aligned by an externally imposed magnetic field perpendicularly to the plane of a substrate. The apparatus of the present embodiment provide the advantage that magnetic layers such as those used in memories including MRAM can be produced at low temperatures including on unheated substrates, as opposed to the typical temperatures used in conventional apparatus, which may be exactly ˜350° C. or greater. The user of an ion beam concurrently with a perpendicularly oriented magnetic field provides further advantages including the ability to apply treatment to a magnetic material very locally in depth. An ion beam can treat a very thin layer (current processes produce implants with ranges down to 10 nm or less) without disturbing the layers beneath or damaging pre-existing structures on a wafer.

In addition, an ion beam and magnetic field of the present embodiments are applied locally in lateral dimensions. An ion beam dimension along the X-direction may be on the order of a few centimeters or less in the present embodiments. Since it is the simultaneous application of a magnetic field and an ion beam that programs the desired alignment within a magnetic material, using an ion beam to assist magnetic alignment reduces the required size of the magnetic field to that of the ion irradiated volume (see region 422) rather than an entire substrate. Moreover, the present embodiments facilitate high throughput processing since ion beams that promote the magnetic alignment process can be rapidly turned on or off. This contrasts with conventional techniques that require heating substrates to elevated temperatures where thermal cycling times including time required for heating and cooling substrates may be undesirably long. The apparatus of the present embodiments may also extend the range of materials available for use as the critical magnetic layers in devices such as MRAMs. Because substrate processing may take place at room temperature or at relatively low substrate temperatures, the choice of magnetic materials can include those that would require too high temperatures (>350° C.) for conventional processing. This wider choice may enable materials with higher anisotropy energies or other desirable characteristics that allow better data retention, faster switching or other features.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. In particular, embodiments detailed above have generally been described with respect to apparatus for generating ion beams that have beamline components. However, in other embodiments apparatus such as plasma doping (PLAD) apparatus may be used to provide ions toward the magnetic alignment apparatus.

Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A system for treating a substrate having a magnetic layer, comprising:
an ion generating apparatus for directing an ion beam to the substrate; and
a magnetic alignment apparatus downstream of the ion generating apparatus and proximate to the substrate and operative to generate a magnetic field that intercepts the substrate in an out of plane orientation with respect to a plane of the substrate,
the magnetic alignment apparatus and ion generating apparatus generating a process region in which the ion beam and magnetic field overlap.

2. The system of claim 1, wherein the magnetic alignment apparatus comprises a magnetic field provider that defines a gap to accommodate the substrate, the system further comprising a substrate holder operative to move the substrate along the second direction when at least a portion of the substrate is exposed to the process region at a given instance.

3. The system of claim 1, wherein the magnetic field provider comprises:
an elongated magnetic concentrator having a long direction perpendicular to the second direction, the elongated magnetic concentrator comprising a tapered shape including a base portion and an upper portion that defines an upper surface having a smaller surface area than the base portion;
a magnet disposed around a lower portion of the elongated magnetic concentrator; and
a return yoke having a pair of distal portions operative to direct the magnetic field toward the upper surface of the elongated magnetic concentrator, the distal portions defining an aperture configured to transmit the ion beam toward the substrate.

3. (canceled)

4. The system of claim 1, the magnetic alignment apparatus operative to generate a magnetic field that intercepts the substrate in a perpendicular orientation with respect to a plane of the substrate.

5. The system of claim 1, the ion generating apparatus and magnetic alignment apparatus operative to generate an ion beam having a trajectory substantially parallel to the magnetic field at the substrate.

6. The system of claim 2 wherein the magnet comprises one of a permanent magnet and an electromagnet.

7. The system of claim 2 wherein the magnetic concentrator comprises a steel material.

8. The system of claim 1 further comprising a heater configured to heat the substrate.

9. The system of claim 1 wherein the ion beam comprises inert gas ions.

10. The system of claim 1 wherein a magnetic field strength of the magnetic field is about 0.1 Tesla or greater.

11. A method for treating a substrate having a magnetic layer, comprising:
arranging a substrate that includes the magnetic layer;
generating over a first area of the substrate a magnetic field in a magnetic field direction out of plane relative to a plane of the substrate; and
directing an ion beam over a second area of the substrate,
wherein the first area and second area overlap at the substrate to define a process region.

12. The method according to claim 11, wherein the magnetic field direction is perpendicular to the plane of the substrate.

13. The method according to claim 11, wherein the ion beam is substantially parallel to the magnetic field direction at the substrate.

14. The method of claim 11, comprising moving the substrate along a scan direction when at least a portion of the substrate is exposed to the process region.

15. The method of claim 1, further comprising:
generating the magnetic field in an elongated magnetic coil;
directing a lower portion of the magnetic field through an elongated magnetic concentrator having a long direction and disposed within the magnetic coil and having a tapered shape comprising a base portion and an upper portion that defines an upper surface having a smaller surface area than the base portion; and
directing an upper portion of the magnetic field toward the upper surface through a return yoke that defines an aperture configured to transmit the ion beam toward the substrate.

16. The method of claim 15, wherein the process region has a process region width along the long direction that ranges from several centimeters to one hundred centimeters and a process region length along a second direction perpendicular to the long direction that ranges from one millimeter to several centimeters.

17. The method of claim 11, further comprising heating the substrate during the directing the ion beam.

18. The method of claim 11, further comprising providing a dose of ions in the ion beam effective to transform a crystal in the magnetic layer from a face centered cubic structure to a face centered tetragonal L1₀ structure.

19. The method of claim 11 wherein the ion beam is a beam of inert species.

20. The method of claim 11, wherein a magnetic field strength of the magnetic field is about 0.1 Tesla or greater.
